(19) United States
(12) Patent Application Publication
(10) Pub. No.: US 2013/0188063 A1
(43) Pub. Date: Jul. 25, 2013

(54) INTERACTIVE PHOTO BOOTH AND ASSOCIATED SYSTEMS AND METHODS

(71) Applicant: COINSTAR, INC., Bellevue, WA (US)

(72) Inventor: Brett W. Cameron, Buda, TX (US)

(73) Assignee: COINSTAR, INC., Bellevue, WA (US)

(21) Appl. No.: 13/745,665

(22) Filed: Jan. 18, 2013

Related U.S. Application Data
(60) Provisional application No. 61/588,825, filed on Jan. 20, 2012.

(51) Int. Cl. H04N 5/272

(52) U.S. Cl. CPC H04N 5/272
USPC 348/207.1; 348/722; 348/207.2

(57) ABSTRACT

The present disclosure is directed to interactive photo booths and associated systems and methods. In one embodiment, for example, an interactive photo booth can include a housing having sidewalls that form an enclosure sized to receive one or more users. The interactive photo booth can also include a backdrop within the enclosure and a camera directed toward the backdrop that takes at least one photo of the users. The interactive photo booth can further include a first user interface in the enclosure and a second user interface on the sidewall of the housing. The first user interface can be configured to receive user selections related to the backdrop, and the second user interface can be configured to edit the photos taken by the camera.

### CROSS-REFERENCE TO RELATED APPLICATION(S)

This application claims the benefit of and priority to U.S. Provisional Patent Application No. 61/588,825, filed Jan. 20, 2012, which is incorporated herein by reference in its entirety.

### TECHNICAL FIELD

The present disclosure relates generally to photo booths and, more particularly, to consumer operated, interactive photo booths and/or associated systems and methods.

### BACKGROUND

Typical photo booths include a camera directed toward a bench positioned on the opposite side of the booth. One or two users can sit on the bench while the camera captures a series of photographs (e.g., 3 to 6 photographs). The photographs are spaced apart by a predetermined time interval, with the photo booth providing a visual or audible signal (e.g., blinking lights or beeps) to the users before each photograph. After taking the last photograph, the photo booth develops the film and delivers the photographs to the users via a slot on the exterior of the photo booth. Typically, photo booths print the series of photos on a strip, but more recently digital processing has resulted in photo booths that print in other orientations (e.g., four photos in a square).

### BRIEF DESCRIPTION OF THE DRAWINGS

FIGS. 1A and 1B are side and isometric views, respectively, of an interactive photo booth configured in accordance with an embodiment of the disclosure.

FIG. 1C is a front view of an exterior portion of the interactive photo booth of FIGS. 1A and 1B.

FIG. 1D is a front view of an interior portion of the interactive photo booth of FIGS. 1A and 1B.

FIG. 1E is a partial cutaway isometric view of the interactive photo booth of FIGS. 1A-1D illustrating users interacting with the photo booth during a studio session.

FIGS. 2A-2H illustrate display pages for initiating a studio session using an interactive photo booth configured in accordance with an embodiment of the disclosure.

FIGS. 3A-3J illustrate display pages for editing photos using an interactive photo booth configured in accordance with an embodiment of the disclosure.

FIG. 4 illustrates a suitable network environment for implementing various aspects of the interactive photo booths of the disclosure.

### DETAILED DESCRIPTION

The present disclosure describes various embodiments of interactive photo booths and associated systems and methods. An interactive photo booth configured in accordance with several embodiments of the disclosure allows users to take photos and digitally edit them on site (e.g., by adding text, graphics, etc.). The interactive photo booth can print the photos in various formats, such as stickers or traditional prints, and can also send digital versions of the photos to the user via email or to social networking sites. Various embodiments of interactive photo booths are described herein with exemplary references to taking and editing photos. However, interactive photo booths configured and/or operated in accordance with the disclosure can be used to produce and edit other types of media, such as videos.

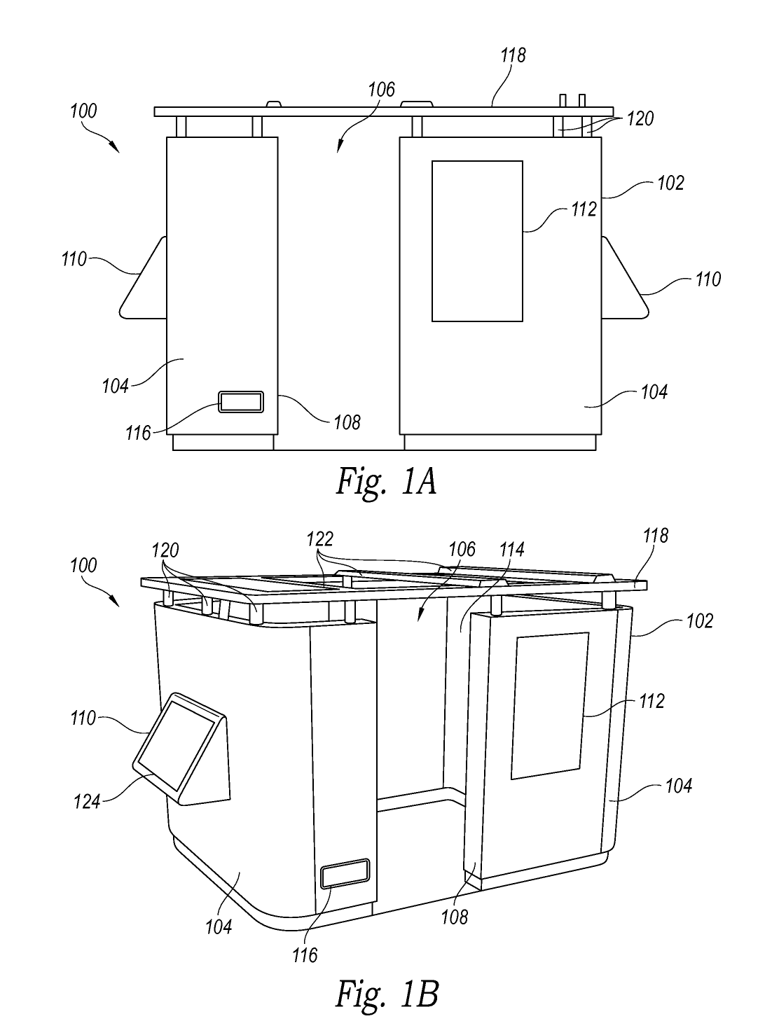

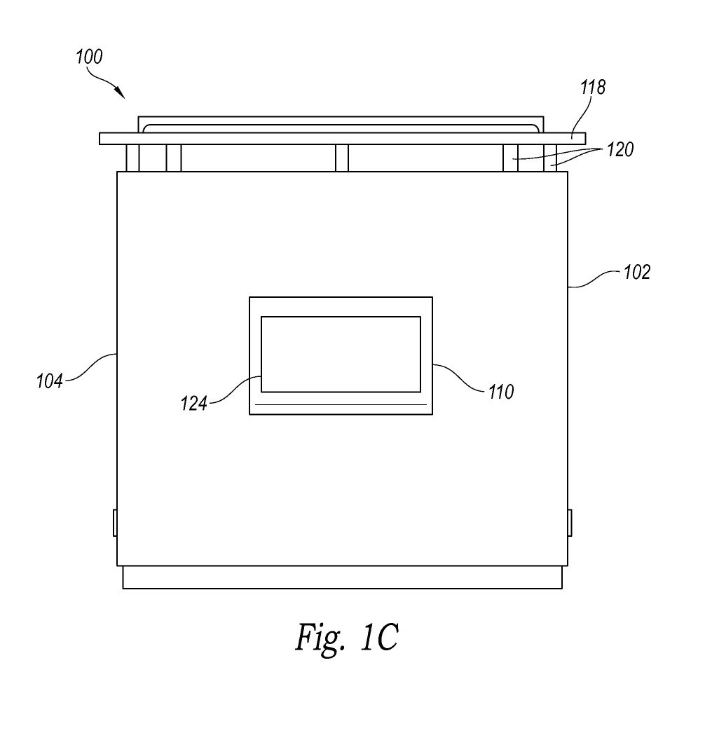

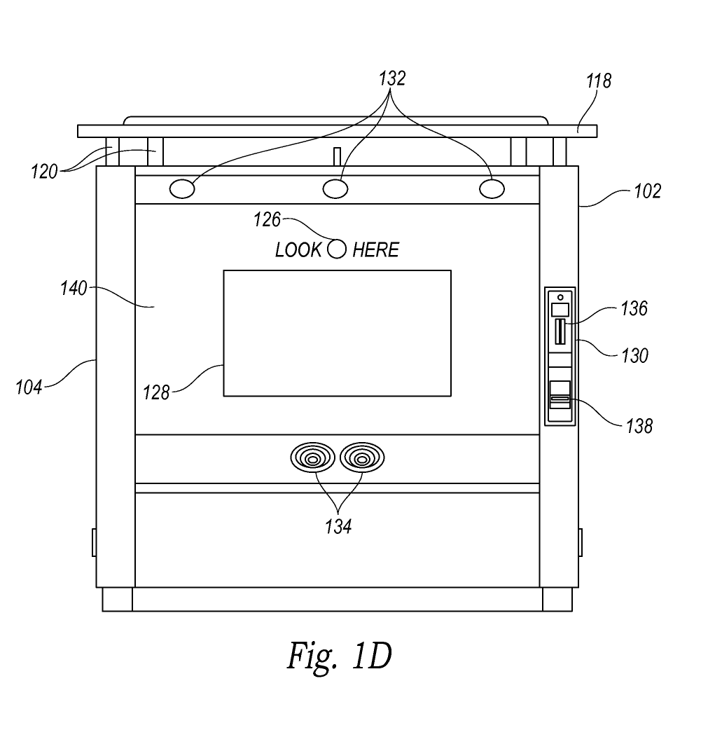

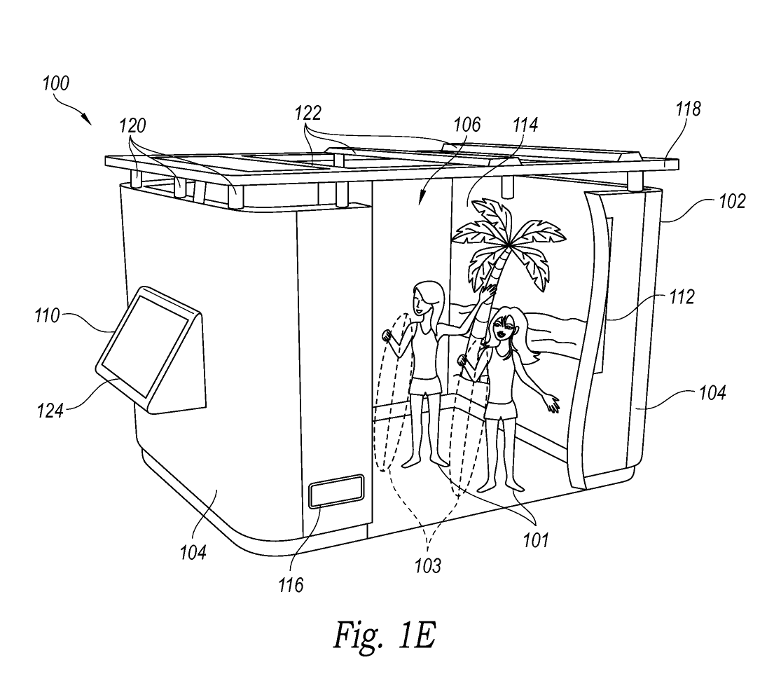

Certain details are set forth in the following description and in FIGS. 1A-4 to provide a thorough understanding of various embodiments of the disclosure. Other well-known structures and systems often associated with consumer operated kiosks, photo booths, and related commerce systems have not been shown or described in detail below to avoid unnecessarily obscuring the descriptions of the various embodiments of the disclosure. Additionally, a person of ordinary skill in the relevant art will understand that the disclosure may have additional embodiments that may be practiced without several of the details described below. In other instances, those of ordinary skill in the relevant art will appreciate that the methods and systems described can include additional details without departing from the spirit or scope of the disclosed embodiments.

Many of the details, dimensions, functions and other features shown and described in conjunction with the Figures are merely illustrative of particular embodiments of the disclosure. Accordingly, other embodiments can have other details, dimensions, functions and features without departing from the spirit or scope of the present disclosure. In addition, those of ordinary skill in the art will appreciate that further embodiments of the disclosure can be practiced without several of the details described below.

Although not required, aspects of the invention are described in the general context of computer-executable instructions, such as routines executed by a general-purpose data processing device, e.g., a server computer, wireless device or personal computer. Those skilled in the relevant art will appreciate that aspects of the invention can be practiced with other communications, data processing, or computer system configurations, including: Internet appliances, hand-held devices (including personal digital assistants (PDAs)), all manner of cellular or mobile phones (including Voice over IP (VoIP) phones), dumb terminals, media players, gaming devices, multi-processor systems, microprocessor-based or programmable consumer electronics, set-top boxes, network PCs, mini-computers, mainframe computers, and the like. Indeed, the terms “computer,” “server,” “host,” “host system,” and the like are generally used interchangeably herein, and refer to any of the above devices and systems, as well as any data processor.

Aspects of the invention can also be embodied in a special purpose computer or data processor that is specifically programmed, configured, or constructed to perform one or more of the computer-executable instructions explained herein. While aspects of the invention, such as certain functions, are described as being performed exclusively on a single device, the invention can also be practiced in distributed environments where functions or modules are shared among disparate processing devices, which are linked through a communications network, such as a Local Area Network (LAN), Wide Area Network (WAN), or the Internet. In a distributed computing environment, program modules may be located in both local and remote memory storage devices.

Aspects of the invention may be stored or distributed on tangible computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the invention may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme).

FIGS. 1A-1C are side, isometric and front views, respectively, of an interactive consumer operated kiosk or photo booth 100 (“booth 100”) configured in accordance with an embodiment of the disclosure. Referring to FIGS. 1A and 1B together, the booth 100 can include a housing 102 having a plurality of sidewalls 104 that form a partially enclosed chamber or enclosure 106. The sidewalls 104 of the housing 102 can include one or more openings 108 that allow users to enter and exit the enclosure 106. The booth 100 can further include one or more user interfaces 110 that can communicate with and receive input from users and, optionally, a display 112 that can provide instructions to the user, display advertisements, and/or otherwise provide users or potential users with information. Within the enclosure 106, the booth 100 can include an interactive backdrop 114 (“backdrop 114”), such as a chroma key (e.g., a “green screen”), a digital screen or monitor, and/or other suitable virtual or digital backgrounds for taking pictures and/or displaying videos.

During a photo or studio session, one or more users (e.g., 3 users, 4 users, 5 users, etc.) can step into the enclosure 106 in front of the backdrop 114 and a camera (described in further detail below) directed toward the backdrop 114 can take one or more photos and/or videos (hereinafter collectively referred to as “photos”) of the users. The users can then edit the photos via the user interfaces 110, and the booth 100 can dispense the edited photos via an output slot 116 and/or other suitable dispensers operably coupled to a photo printer (e.g., a digital photo printer; not shown) and/or other suitable media printing device within the housing 102. The booth 100 may also be configured to send digital images to a remote site. The booth 100, for example, can be configured to send digital photos to users via email, via text message or wirelessly to users' smart phones, to a remote website (e.g., a social networking site or digital photo storage site), etc.

The booth 100 can be sized to allow multiple users (e.g., 3 users, 5 users, 8 users, 10 users, etc.) to enter the enclosure 106 at one time and take photos together. In one embodiment, for example, the booth 100 can have a length of about 8.5 feet (2.6 m), a width of about 6.5 feet (2.0 m), and height of about 6.5 feet (2.0 m) to allow approximately eight users to fit within the enclosure 106 for picture taking purposes. In other embodiments, the booth 100 may have other dimensions (e.g., 4.5 feet (1.4 m) by 6 feet (1.8 m)) to fit larger or smaller groups of users within the enclosure 106.

As shown in FIGS. 1A-1C, the user interfaces 110 can be positioned on the exterior of the booth 100 to allow users to edit their pictures after a studio session. This allows subsequent users to enter the enclosure 106 and engage in a studio session of their own while the previous users edit their pictures, and therefore facilitates more user interaction with the booth 100 at one time. In the illustrated embodiment, the booth 100 includes two user interfaces 110 positioned on opposite sidewalls 104 of the housing 102 so that two users or two groups of users can edit their photos at the same time. In other embodiments, the booth 100 can include one or more than two user interfaces 110, and/or one or more of the user interfaces 110 can be positioned on different portions of the booth 100 (e.g., within the enclosure 106). In further embodiments, the user interface 110 can be spaced apart from the booth 100 (e.g., as part of a separate kiosk positioned proximate to the booth 100) and communicatively coupled thereto.

The user interface 110 can be configured to allow one or more users to edit the photos taken by the booth 100, select printing methods (e.g., stickers, photos, etc.), electronically send the photos to remote sites or devices (e.g., wirelessly via blue tooth to handheld devices) and/or to social networking sites (e.g., Facebook®) using a communications link described in further detail below, set up and manage user accounts, and/or otherwise interface with users. Each user interface 110 can include a touch screen 124 that provides information to and receives information from users. The touch screens 124 can be relatively large (e.g., 36 inches (91.4 cm) by 28 inches (71.1 cm) to allow multiple users to view and/or contact the touch screens 124 at one time. In other embodiments, the touch screen 124 can have smaller or larger dimensions. In certain embodiments, the touch screens 124 can be a multi-touch screen that allows multiple users (e.g., two or more users) to simultaneously edit the photos. In one embodiment, for example, the touch screen 124 can be configured to receive and operatively interact with at least two different touches (e.g., three touches, five touches, 10 touches, 30 touches) at one time. In further embodiments, the user interface 110 can include other suitable input and/or output devices that can provide and/or receive consumer information. For example, the booth 100 can include a display (e.g., a screen or monitor), keyboard, and/or a voice command device.

In the illustrated embodiment, the display 112 is positioned on the exterior of the housing 102 to provide information related to the booth 100 and/or other signage to users and potential users walking by the booth 100. The display 112, for example, can play videos or images of current or previous users during a studio session to attract potential customers. The display 112 can be a screen, a monitor, a digital read out, and/or other suitable devices configured to provide visual and/or audio information to consumers. In various embodiments, the display 112 can be a touch screen or other type of display that allows users and/or others passing by to interface with the booth 100. The display 112, for example, can be configured to display a plurality of images (e.g., of previous photos taken at the booth 100, of scenes for the backdrop 114, etc.), and allow passersby to select (e.g., by touching the image) the image they prefer. In this embodiment, the display 112 can be used as a polling mechanism to rate backgrounds for the backdrop 114 and customize the backgrounds used in the booth 100 for the specific booth location. In other embodiments, the booth 100 can include additional displays, and/or the display 112 can be positioned elsewhere on or coupled to the booth 100.

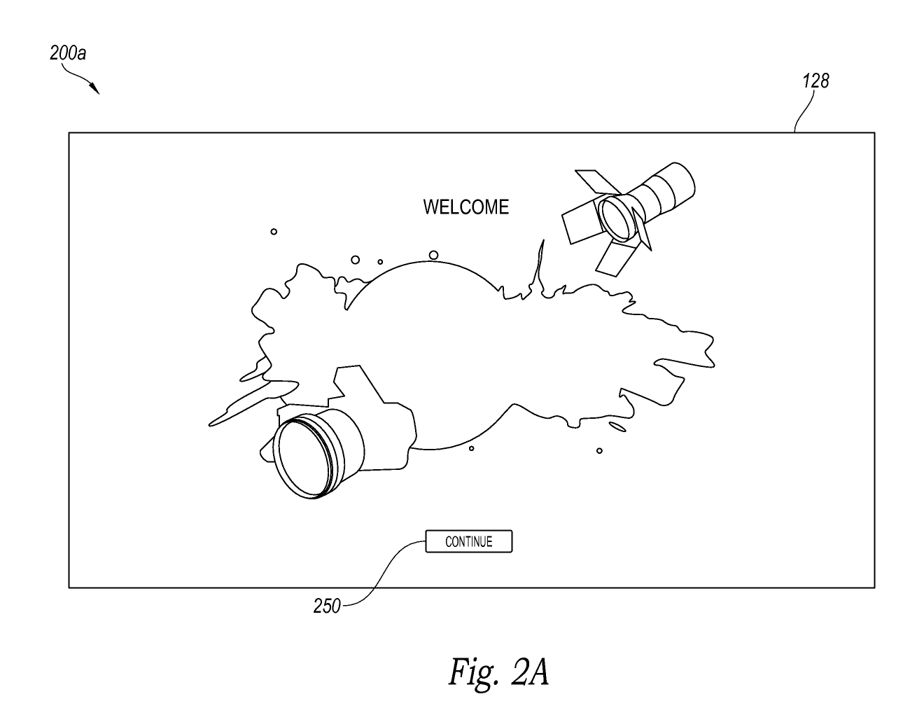

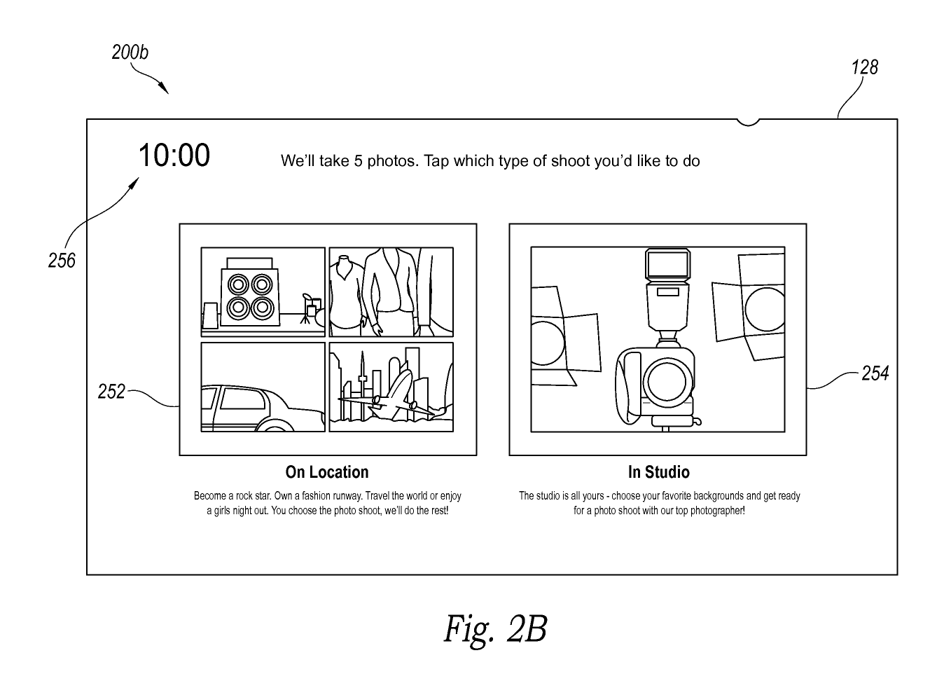

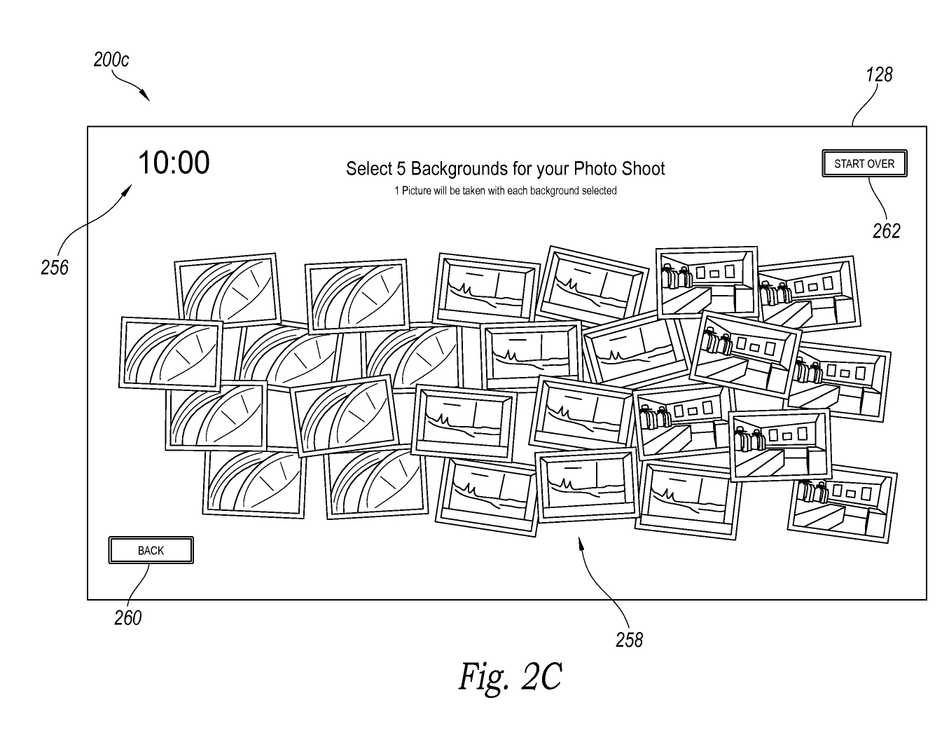

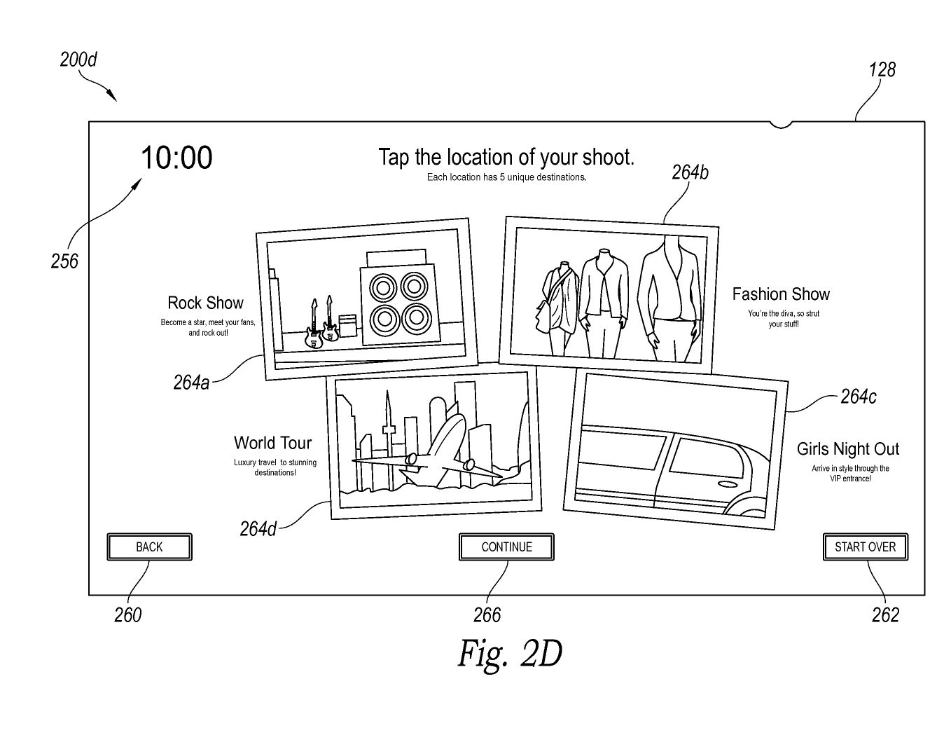

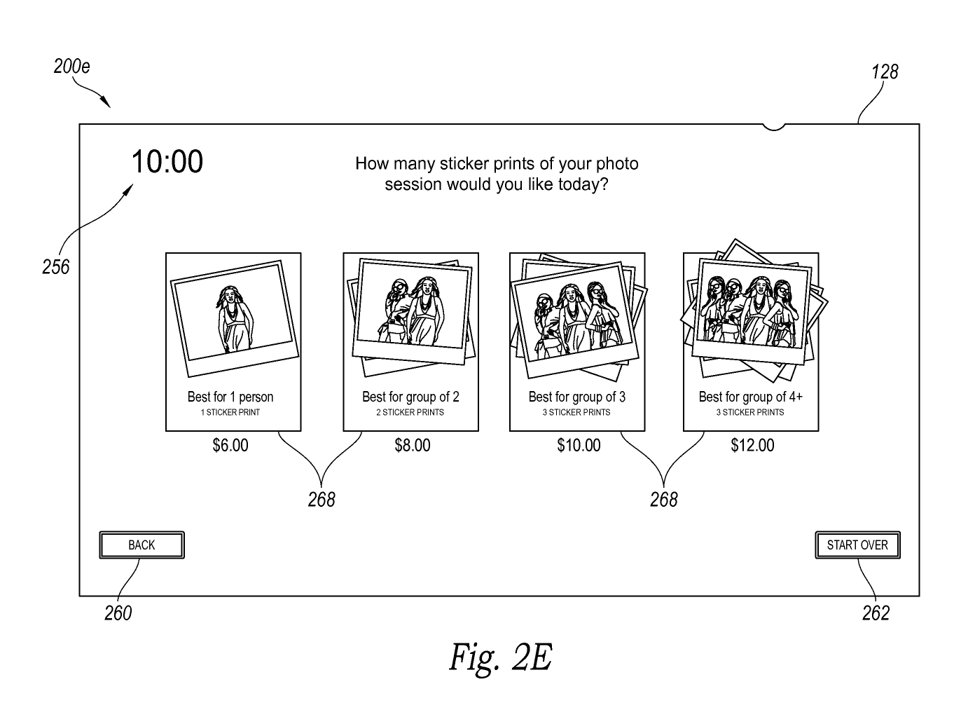

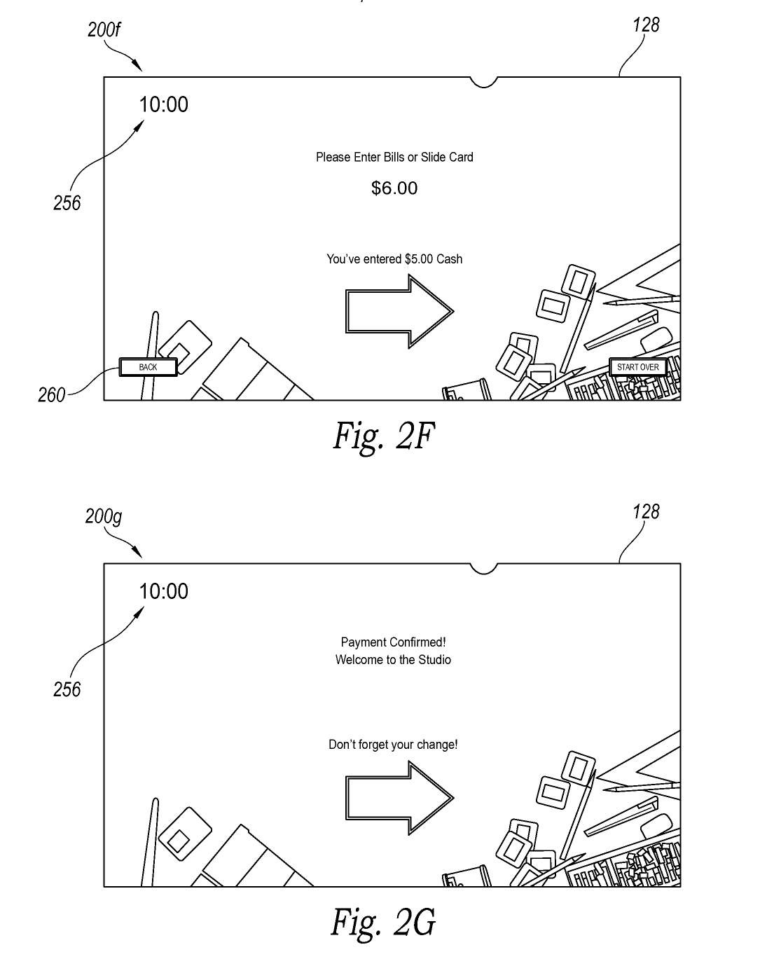

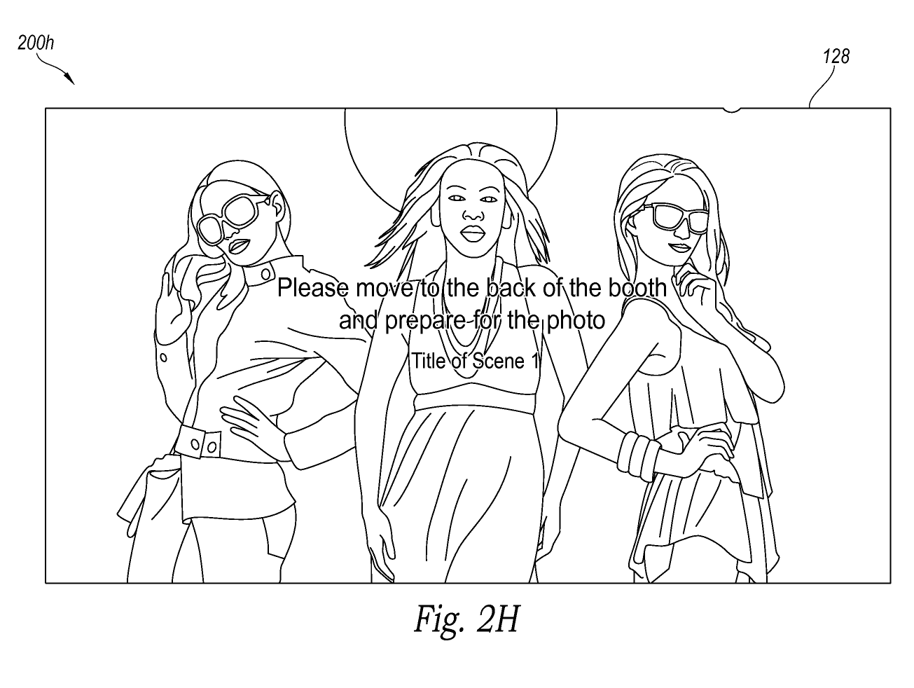

The screens of the user interfaces 110 and/or the display 112 may be implemented in any of various ways, such as in C++ or as web pages in XML (Extensible Markup Language), HTML (HyperText Markup Language) or any other scripts or methods of creating displayable data, such as the Wireless Access Protocol (“WAP”). The screens or web pages provide facilities to present information and/or receive input data, such as a form or page with fields to be filled in, pull-down menus or entries allowing one or more of several options to be selected, buttons, sliders, hypertext links or other known user interface tools for receiving user input. While certain ways of displaying information to users is shown and described with respect to certain Figures (e.g., FIGS. 2A-2H), those skilled in the relevant art will recognize that various other alternatives may be employed. The terms “screen,” “web page” and “page” are generally used interchangeably herein.

In various embodiments, the booth 100 can further include a roof structure 118 that extends over the enclosure 106. In the illustrated embodiment, for example, the roof 118 is offset from the sidewalls 104 by a plurality of supports 120 to create a partial or floating ceiling structure over the enclosure 106. The roof 118 can also have a plurality of beams or panels 122 (FIG. 1B) spaced apart from one another to provide openings above the enclosure 106. In other embodiments, the roof 118 can more fully cover the top of the enclosure 106 to provide more privacy for users during a photography session. The roof 118 can include lighting features, such as LEDs and/or other theme lighting, fans, speakers, and/or other suitable features that can provide a desired ambiance within the enclosure 106. The booth 100 can also optionally include a curtain, screen, and/or covering that can be removably positioned over the openings 108 to provide privacy for the users during a studio session. In other embodiments, the sidewalls 104 can extend entirely around the enclosure 106, and the booth 100 can include one or more doors to access the interior of the booth 100.

FIG. 1D illustrates an interior portion of the booth 100 opposite the backdrop 114 (FIG. 1B) and configured in accordance with an embodiment of the disclosure. In the illustrated embodiment, the booth 100 includes one or more cameras 126 and a monitor or screen 128 directed generally toward the backdrop 114 (FIG. 1B). The camera 126 can be a film or digital camera configured to take still frames or videos of users in front of the backdrop 114 during studio sessions. The screen 128 can provide the user with instructions before, during, and/or after a studio session (e.g., a count down before a photo is taken), and/or show images of the users before, during, and/or after each photo. The screen 128, for example, can be configured to display a live video of the users in front of the backdrop 114 to allow the users to position themselves as desired with respect to the backdrop scene. The screen 128 can also be configured to display a snapshot of each photo after it is taken to allow the users to adjust themselves as desired before a subsequent photo is capture. In some embodiments, the screen 128 can be a touch screen that interacts with users while they are in the enclosure 106.

In the illustrated embodiment, the interior of the housing 102 further includes a lighting panel 140 (e.g., including LED lights) that provides lighting effects that enhance the experience of the studio session. The lighting panel 140 can surround the screen 128 as shown in FIG. 1D, or can be otherwise positioned in the enclosure 106. In other embodiments, the screen 128 and the lighting panel 140 are combined into a large screen that provides both lighting and suitable displays.

The interior of the booth 100 can further include a plurality of speakers 132 that can provide audible instructions to users within the enclosure 106 (e.g., warning users when the camera 126 is about to take a photo), music, and/or other sounds to enhance the user experience in the studio session. One or more fans 134 can also be positioned within the enclosure 106 to further enhance the ambiance of the studio session. In various embodiments, the speakers 132 can play music and sound effects related to the image produced on the backdrop 114 (e.g., techno music for a club scene, country music and galloping noises for a rodeo scene, cheering fans at a sporting event scene, etc.) and the fans 134 can create the effect of hair blowing in the wind. In other embodiments, for example, the speakers 132 can be configured to stream music selected by the user and/or related to the types of images produced on the backdrop 114 in the studio session. In the illustrated embodiment, the speakers 132 and the fans 134 are shown on one wall 104 of the booth 100. In other embodiments, however, the speakers 132 and/or fans 134 can be positioned elsewhere within and/or proximate to the enclosure 106. In further embodiments, the booth 100 can include additional features that enhance the user experience, such as fog machines.

As shown in FIG. 1D, a payment interface 130 can also be positioned within the enclosure 106 to receive one or more forms of payment from users for each studio session. The total cost of the studio session can be conditioned on the number of prints, the type of prints selected (e.g., standard photo or sticker), the number of photos taken, and/or other suitable parameters. The payment interface 130 can include, for example, a credit card reader 136 (e.g., a magnetic card swipe) and/or a currency acceptor 138 (e.g., a bill acceptor, change slot, etc.). In other embodiments, the payment interface 130 can be positioned at another portion of the booth 100 (e.g., on the exterior of the booth 100 proximate one or more of the user interfaces 110) and/or the booth 100 can include other mechanisms to accept payment (e.g., via credit card information entered via the screen 128).

In operation, the booth 100 can provide users with a fully automated, immersive experience during each studio session, followed by the ability to edit the resultant photos on site. The edited photos can be printed at the booth 100, sent via email as digital images, and/or uploaded to various sites. The digital images, for example, can be uploaded to social networking sites (e.g., Facebook®, Twitter®, etc.), photo storage websites (e.g., Shutterfly®, Snapfish®, Zazzle®, etc.), user accounts (e.g., stored on a remote database), and/or other remote locations. The backdrop 114 can produce various backgrounds via chroma key compositing, digital displays, and/or other suitable technologies. During a studio session, the user can select an “on location” option that allows the user to take a series of photos all related to the same theme, such as a rock concert. To enhance the ambience of the studio session, the speakers 132 can provide related audio (e.g., fans screaming, crowd roaring, and pop or rock music in the background), the fans 134 can serve as blowers that create slight hair movement, and/or the lighting within the enclosure 106 (e.g., from overhead lighting on the roof 118 and/or the lighting panel 140) can provide associated lighting effects (e.g., stage lighting) and/or visual images related to the theme (e.g., a crowd of fans). The booth 100 can also be configured to include an “in-studio” option that allows users to select one or more backgrounds from a library of backgrounds (e.g., historical landmarks, holidays, eras, etc.) to enable users to create their own experience during their studio session. In some embodiments, the booth 100 can also allow the user to select the backgrounds (e.g., from a user account associated with the booth 100), audio (e.g., stream music), lighting, and/or other operating parameters of the studio session to further personalize the experience. In other embodiments, the booth 100 can be configured to receive a code (e.g., a promotional code from the user), and provide backgrounds associated with the code. A code, for example, can be provided to the user by a retailer or as part of a movie promotion. Once the user enters the code at the booth 100, the booth 100 can provide background scenes associated with the retailer or movie.

Once the background for the studio session is selected, the booth 100 can activate the appropriate features (e.g., the speakers 132, the fans 134, the screen 128, the light display 140, etc.) and the camera 126 can proceed to take one or more photos (e.g., 5 photos) of the users in front of the backdrop 114. The screen 128 and/or other features of the booth 100 (e.g., the speakers 132) can be configured to indicate to the users when the next photo will be taken. In some embodiments, the screen 128 can also display live images of the users that represent the camera frame to allow the users to orient themselves as desired. In other embodiments, the screen 128 can display each photo immediately after it is taken to allow the users to reposition themselves or correct their poses before the next photo is taken. The display 112 on the exterior of the booth 100 can also display the studio session taking place within the booth 100 and/or other suitable advertisements that can appeal to potential users walking by the booth 100. The booth 100 may have a predetermined time limit (e.g., 5 minutes, 10 minutes, etc.) for each studio session and/or for the user selection period to facilitate efficient user interactions with the booth 100 and reduce the likelihood of delays for subsequent users.

In various embodiments, the booth 100 can be configured to provide scenes or backgrounds on multiple planes (e.g., rather than a single dimensional green screen) and the camera 126 can be a multiplane camera to generate photos with a three-dimensional effect. FIG. 1E, for example, is a partial cutaway isometric view of the booth 100 illustrating users 101 interacting with the backdrop 114 during a multiplane studio session. For illustrative purposes, FIG. 1E depicts the image the users 101 see on the screen 128 (FIG. 1D) during the studio session (e.g., the scene projected onto the backdrop 114). The multiplane studio session can provide various elements of a selected scene on different planes, and thereby allow the users 101 to position themselves in front of or behind the scene elements to provide photos with a three-dimensional effect. In the illustrated embodiment, for example, the selected background is a beach scene with palm trees and a sandy beach provided on the backdrop 114 behind the users 101 and surfboards 103 (shown in broken lines) provided on a different plane than the background. The users 101 can therefore position themselves in a plane between the backdrop 114 and the surfboards 103, and interact with the scene elements positioned on different planes (e.g., peeking out from behind the surfboards 103). In other embodiments, the booth 100 can provide other multiplane scenes that can provide an interactive experience for the users 101 and photos with a three-dimensional effect.

In various other aspects of the technology, the booth 100 and/or features thereof (e.g., the camera 126) can include facial/body recognition software that allows the booth 100 to locate the position of the users' heads while in the booth 100. Elements of the selected background can then be positioned based on the location of the users' head or body. An animated character's head, for example, can be positioned over a user's head, or a character's body can be positioned over the user with the user's face taking the place of the character's face. In other embodiment, other portions of the scene can be positioned with respect to a user's face or body (e.g., a palm tree can be positioned such that the user's face is located in a coconut of the palm tree). These augmented realities can be incorporated into the studio session (e.g., shown in a multiplane view, displayed for the user, etc.), or can be incorporated into the photos during editing (e.g., automatically by the booth 100 and/or by the user).

After the studio session, users can edit one or more of the photos taken during the studio session using the user interface 110. In various embodiments, for example, the users can selected the filter on each photo, add text or images (e.g., clip art), scale the size of the photos, and/or otherwise manipulate the photos. In other embodiments, the user can edit photos on the screen 128 within the enclosure 106. The edited photos can be printed as pictures, stickers, and/or other suitable formats at the booth 100 (e.g., via a digital photo printer) and dispensed to the users via the slot 116. In some embodiments, the booth 100 can be communicatively linked to a network (e.g., via the Internet, etc.; described in further detail below) to allow the users to send digital versions of the edited photos via email and/or text message, and/or share the digital photos via social networking sites. In some embodiments, the booth 100 can be configured to send a hyperlink to users via email or text message, and the hyperlink can take users to a site that includes digital versions of the users' photos taken at the booth 100. The users can then further edit the photos at the site (e.g., from a home computer, tablet, smart phone, etc.), order additional prints of the edited or unedited photos, and/or purchase consumer goods (e.g., smart phone covers, tablet covers, binders, pillows, etc.) with the photos printed thereon. In certain embodiments, the hyperlink can direct users to a site that already has the users' photos displayed on the consumers items (e.g., smart phone cover) to provide the users with visual representations of the personalized consumer items that can be ordered from the site.

In further embodiments in accordance with the disclosure, the studio sessions can capture videos of users during studio sessions that can, if desired, be edited at the booth 100 and/or from a remote location coupled to the booth 100. The studio sessions, for example, may allow users to star in a music video or broadcast a news report. In some embodiments, the booth 100 can be configured to allow users to virtually interact with people, animals, and/or other objects. In this embodiment, the booth 100 can take videos as users interview their favorite celebrity, walk the red carpet with paparazzi, and/or perform other selected activities provided by the booth 100.

In various embodiments, the booth 100 can receive user information to identify users and associate the users with transactions at the booth 100 and/or interactive photo booths communicatively linked to the booth 100 within the same network. The booth 100, for example, can be configured to receive a user's email address or user login information associated with a user account created at the booth 100 via the user interface 110 and/or remotely on a website (e.g., accessed from a home computer, smart phone, etc.). The booth 100 can also be configured to identify users from credit or debit card information (e.g., read via the payment device 130) and/or otherwise identify the consumer. In certain embodiments, for example, the booth 100 can include facial recognition software that allows the booth 100 to recognize the user as he or she steps into the booth 100. The booth 100 and/or a remote computer linked thereto can use the user information to track the user's transactions at the booth 100 and booths within the same network so that the user can access the photos taken at the booth from a remote location (e.g., a website). The user accounts can also allow users to access previous studio sessions from a remote location. In some embodiments, for example, users can access their user accounts to further edit their photos, order additional prints, and/or order consumer products with their photos printed thereon.

The booth 100 described above can operationally interface with users via visual and/or audible signals, textual instructions, animations, dialogue boxes, selector buttons, icons, prompts, and/or other features provided to users via the user interface 110 on the exterior of the booth 100 and/or the screen 128 (e.g., a touch screen) within the enclosure 106. FIGS. 2A-2H, for example, illustrate display pages 200a-h on the interior screen 128 that can be used to initiate a studio session in the booth 100. In other embodiments, one or more of the display pages 200a-h can be displayed on other portions of the booth 100 (e.g., on the user interface 110) or on displays operably coupled to the booth 100.

Referring first to FIG. 2A, the display page 200a can include welcome screen with a “Continue” icon or button 250 that allows a user (i.e., one or more customers) to begin a studio session and navigates the screen 128 to the display page 200b illustrated in FIG. 2B. There, the user can select from an “On Location” button 252 that allows the user to choose from various themes that can be displayed on the backdrop 114 (FIG. 1B) during the studio session or an “In Studio” button 254 that allows the user to select individual backgrounds from a collection backgrounds to create a personalized user experience. In other embodiments, the display page 200b can include other options related to the format of the studio session. In various embodiments, navigating to the display page 200b shown in FIG. 2B can initiate a timer 256 that specifies the total time remaining in the studio session. For example, the timer 256 can limit the studio session to ten minutes or other suitable times. This may include the time used to select the parameters of the studio session, or it may only pertain to the time period in which the booth 100 takes photos of the user.

When the user selects the “In Studio” button 254, the screen 128 navigates to the display page 200c illustrated in FIG. 2C, which includes a plurality of different backgrounds 258 that the user can select for his or her studio session. The display page 200c can also include instructions for the user to a select a different background for each photo during the studio session (e.g., 5 backgrounds for 5 photos), and/or the display page 200c can allow the user select the same background for multiple photos. If the user is unsatisfied with the “In Studio” selection, the user can select a “Back” button 260 to navigate to the previous display page 200b (FIG. 2B) or a “Start Over” button 262 to restart the session.

When the user selects the “On Location” button 252, the screen 128 navigates to the display page 200d illustrated in FIG. 2D. The display page 200d includes a plurality of different themes 264a-d that represent different locations that the user can select for the studio session, such as a “Rock Show” theme 264a, a “Fashion Show” theme 264b, a “Girls Night Out” theme 264c, and a “World Tour” theme 264d. In other embodiments, the display page 200d can display a greater or fewer number of themes from which the user can select.

Once the user has chosen a theme 264, selecting the “Continue” button 266 can navigate the screen 128 to the display screen 200e shown in FIG. 2E. The display page 200e can include various different print options 268 with associated prices and recommendations as to which print option 268 would be most appropriate for a given group size. For example, one print can cost $6.00, and each additional print can be bought for an additional fee (e.g., $2.00).

As illustrated in FIG. 2F, the screen 128 can navigate to the display page 200f that instructs the user to pay the cost associated with the selected print option 268 (e.g., via the payment device 130 shown in FIG. 1D). In various embodiments, the display page 200f can countdown the amount still owed and/or the total amount entered until the full payment due has been entered. In FIG. 2G, the display page 200g confirms that payment has been received, and the screen 128 can then navigate to the display page 200g shown in FIG. 2H that instructs the user to get in the appropriate position (e.g., near the backdrop 114) for photos as the studio session begins. In some embodiments, the screen 128 can also show live images of the user to facilitate positioning within the camera angle.

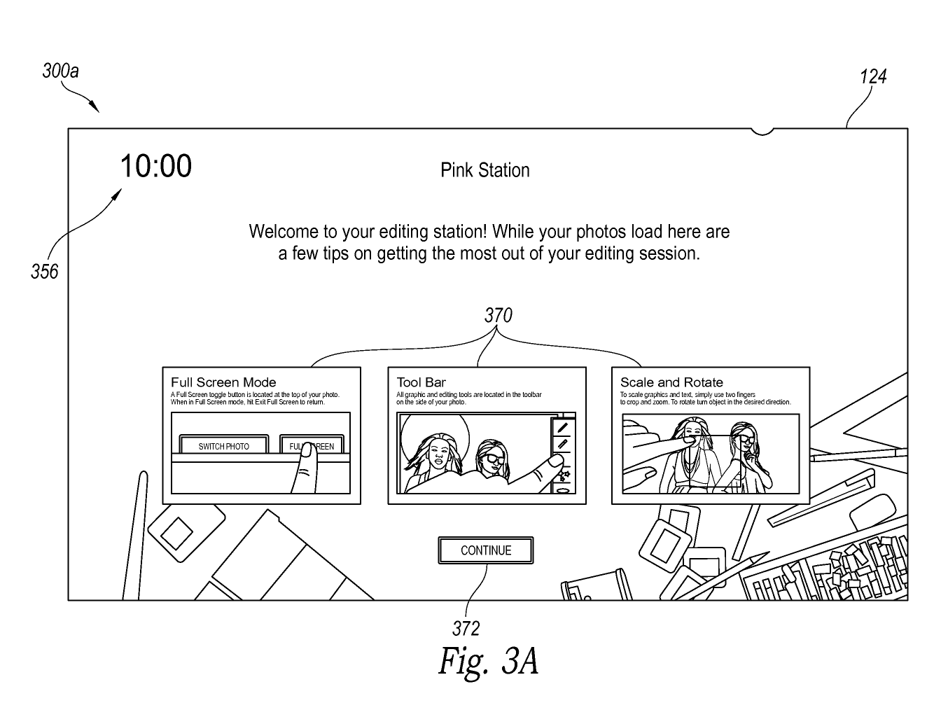

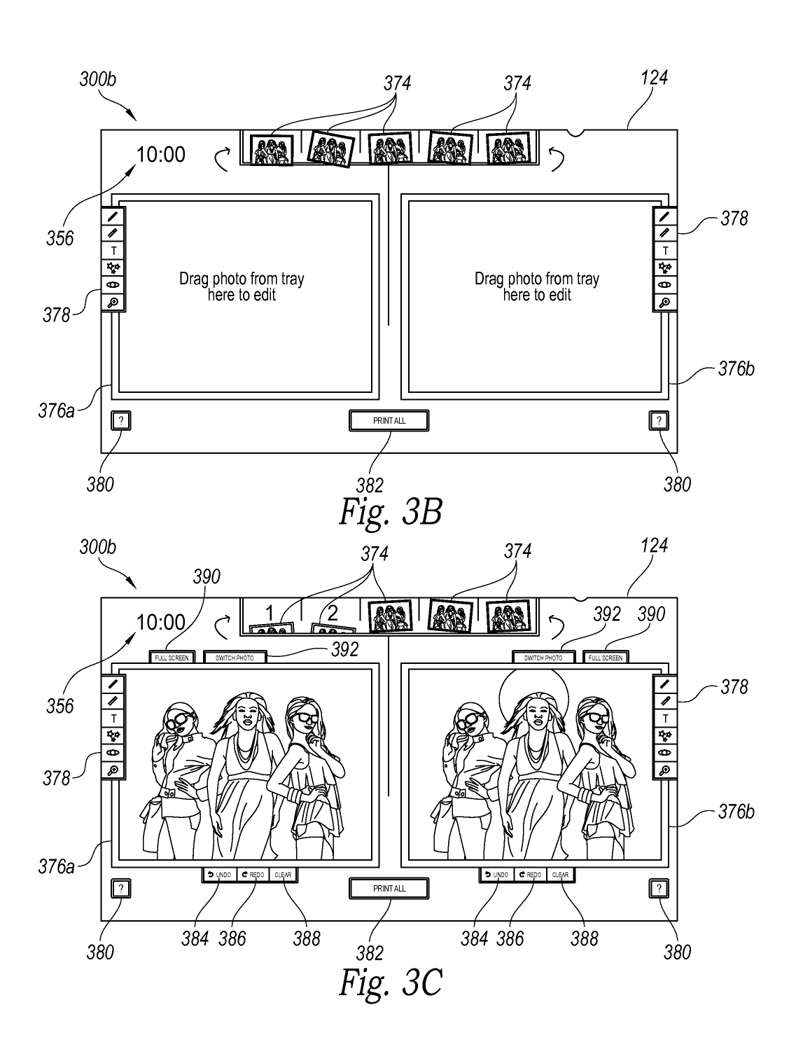

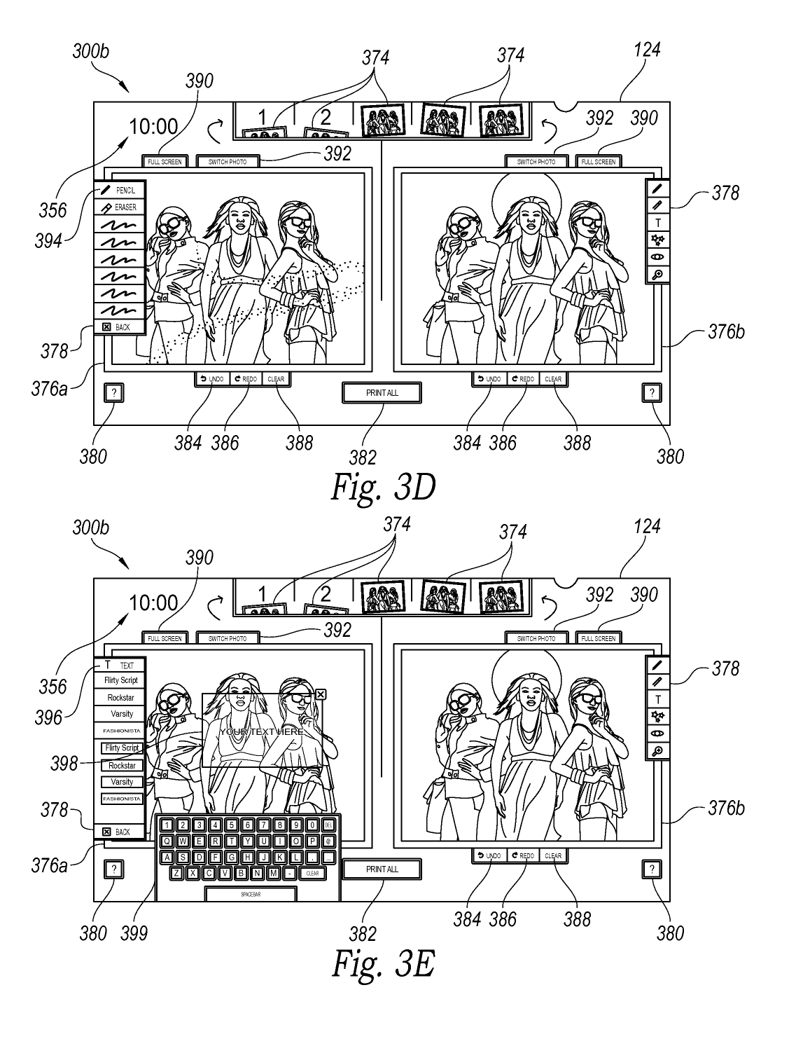

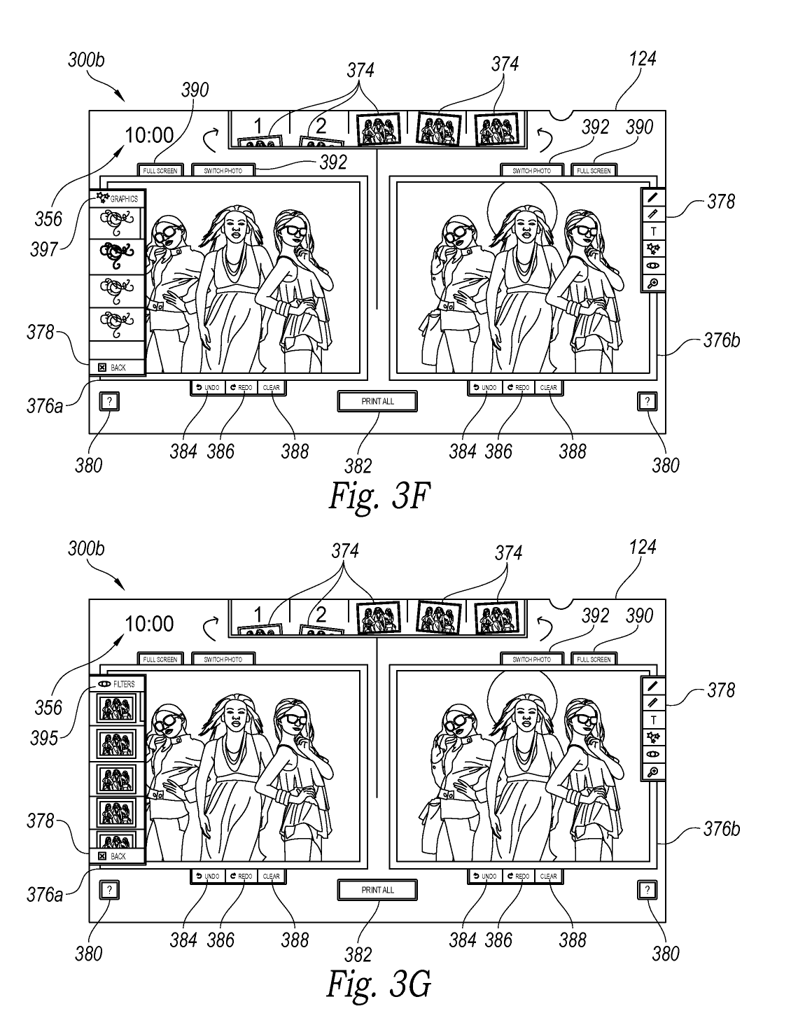

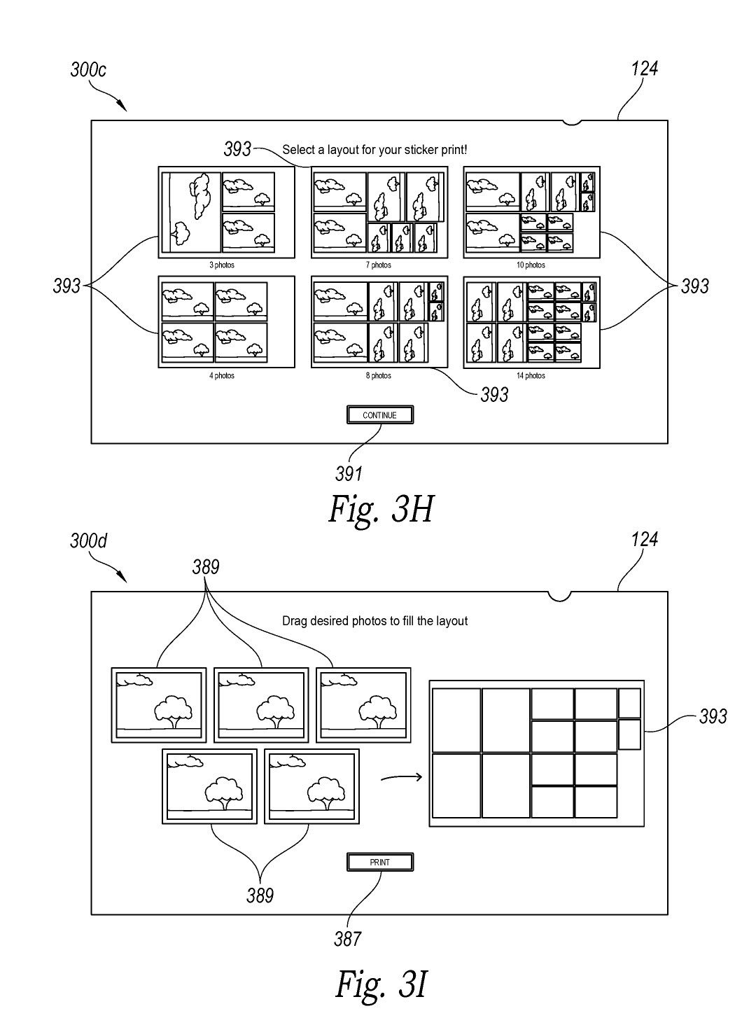

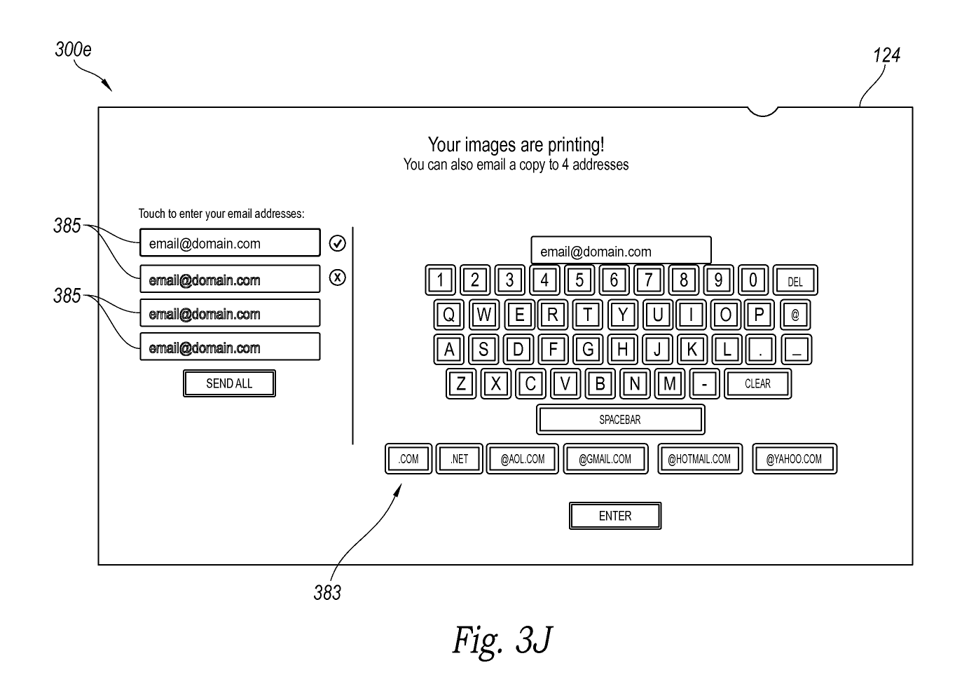

After the studio session, the user can move to the user interface 110 on the exterior of the booth 100 to edit the photos taken during the studio session and allow subsequent users to partake in studio sessions within the enclosure 106. FIGS. 3A-3J, for example, illustrate display pages 300a-e for editing photos using the touch screen 124 in accordance with an embodiment of the disclosure. Referring first to FIG. 3A, the display page 300a can include various tips 370 and/or other information related to the photo editing process while the photos from the studio session are loaded at the editing station. In various embodiments, a user can select one of the tips 370 to initiate a pop-up window that provides further information. The display page 300a can also include a clock 356 that counts down from a predetermined time interval (e.g., 10 minutes) to inform users of the time remaining in their editing session. This predetermined time interval can be approximately equivalent to the time period associated with the studio session so that one user can finish editing just as the next finishes a studio session, and thereby reduce the likelihood of delays at the booth 100. If the booth 100 includes more than one touch screen 124 and/or other user interface 110 for editing photos, the booth 100 can allot more time to each user for editing.

Once the photos have been loaded, the touch screen 124 can navigate to the display page 300b illustrated in FIG. 3B automatically or by selecting the “Continue” button 372. The display page 300b can include thumbnails 374 corresponding to the photos taken during the studio session. The user can drag or otherwise move individual thumbnails 374 to larger editing areas or fields 376 (identified individually as a first editing field 376a and a second editing field 376b). Each editing field 376 can include a separate editing toolbar 378 and help button 380. The editing toolbars 378 can include a plurality of buttons corresponding to different ways users can manipulate the photos. The help button 380 can provide access to a menu that assists users with various questions they may have during the editing process. During any point of the editing process, users may select a “Print All” button 382 that initiates a printing process described below beginning with FIG. 3H.

As discussed above, in various embodiments the touch screen 124 can be capable of responding to a plurality of different touches (e.g., 2 touches, 5 touches, 15 touches, 20 touches, 30 touches, etc.), and therefore allow two or more users to simultaneously edit the photos. One user, for example, can edit one of the photos in the first editing frame 376a, while another user can edit a different photo or the same photo in the second editing frame 376b. In other embodiments, the display page 300b can include additional editing frames 376 so that more photos can be edited simultaneously.

As shown in FIG. 3C, the display page 300b can indicate which photos are currently being edited by hiding a portion of the corresponding thumbnails 374 and/or otherwise differentiating the thumbnails 374 corresponding to the photos in the editing fields 378. Each editing field 376 can include an “Undo” button 384, a “Redo” button 386, a “Clear” button 388, and/or other suitable buttons that allow the user to revise previous edits made to the photo in the corresponding editing field 376. The editing fields 376 can also include a “Full Screen” button 390 that expands one of the edited photos across a larger portion of the touch screen 124 and a “Switch Photo” button 392 that allows the user to select a different photo from the thumbnails 374 to edit.

Each editing toolbar 378 can include various different buttons that allow users to manipulate the photos. As shown in FIG. 3D, for example, the user can select “Pencil” button 394 from the editing toolbar 378 that allows the user to draw images (e.g., lines, text, pictures, etc.) on the photo using his or her finger and/or a stylus operably coupled to the touch screen 124. In various embodiments, the user can select the color of the pencil from a plurality of colors displayed on the editing toolbar 378.

When the user selects a “Text” button 396 (FIG. 3E), a text box 398 and a virtual key board 399 can pop up on the display page 300b to allow the user to add text to the photo. The editing toolbar 378 can be configured to display various font styles from which the user can choose. As shown in FIG. 3F, the editing toolbar 378 can further include a “Stamp” button 397 that allows the user to select from a variety of stamps or images that can be placed on the photo. The editing toolbar 378 can further include a “Filter” button 395 (FIG. 3G) that retroactively changes the filter of the photo. For example, the photo can be manipulated to have a sepia filter, a black-and-white filter, and/or other suitable filters. In other embodiments, the editing toolbar 378 can include additional editing buttons (e.g., a colorize button that add or change the colors on selected portions of the photo) and/or some of the buttons can be omitted.

After the user is satisfied with the edits, the user can select the “Print All” button 382 to navigate the touch screen 124 to the display page 300c illustrated in FIG. 3H. The display page 300c can include a plurality of templates 393 that illustrate different layouts in which the user can arrange the photos. Once the user has selected a desired layout 393, the touch screen 124 can navigate to the display page 300d shown in FIG. 31 using the “Continue” button 391 (FIG. 3H). The display page 300d can include the selected template 393 and images of the edited photos 389 that the user can drag and/or otherwise move to various positions within the template 393. After the photos have been placed in the template 393, the user can select a “Print” button 387 that causes the booth 100 to print and dispense the edited photos as positioned in the template 393. In various embodiments, the touch screen 124 can provide options to the user as to whether the user would like the edited photos to be printed on tacky backing so they can be used as stickers, as conventional photographs, and/or on other suitable substrates.

As shown in FIG. 3J, the touch screen 124 can navigate to the display page 300e while the photos are being printed. The display page 300e can include one or more fields 385 in which the user can enter email addresses (e.g., via a virtual key board 383) and/or smart phone numbers to which the booth 100 can send digital images of the edited photos. In various embodiments, the touch screen 124 can provide additional display pages that allows the user to communicate with social networking sites such that the user can post the edited photos (e.g., on Facebook, Twitter, etc.).

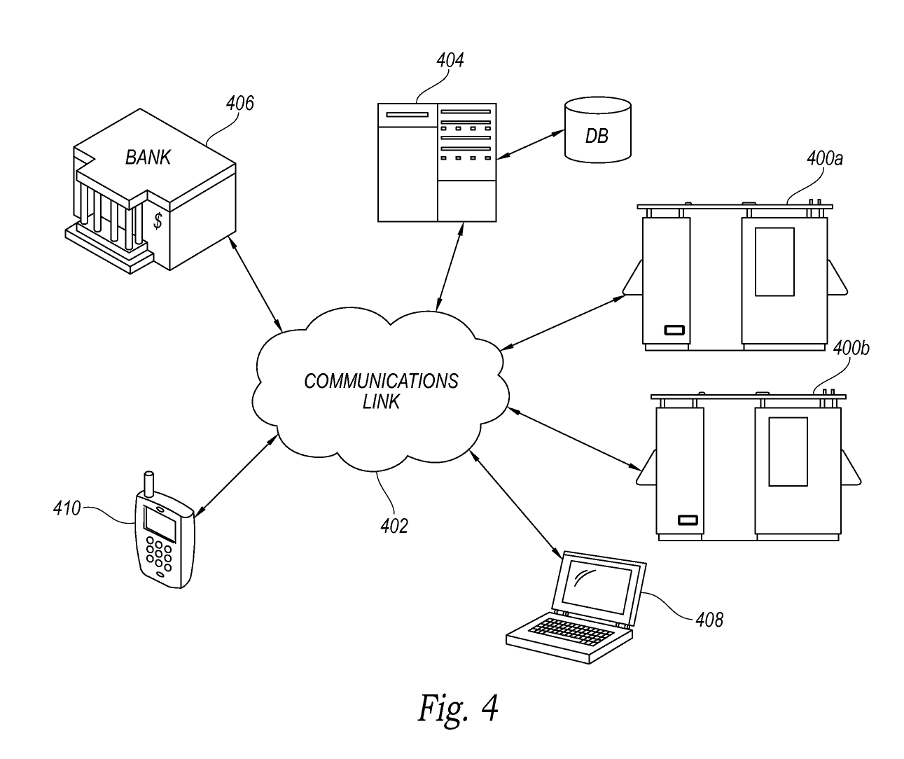

FIG. 4 illustrates a suitable network environment for implementing various aspects of the interactive photo booths described above. One or more interactive photo booths 400 (identified individually as a first booth 400a and a second booth 400b) can be operatively connected to a server 404 via the Internet, a dedicated network, and/or other communications link 402. Many features and aspects of the booths 400 are at least generally similar in structure and function to the booth 100 described in detail above. In some embodiments, the booths 400 are first networked to one or more host computers (not shown), which are in turn operatively connected to the communications link 402. The server 404 performs much or all of the functions for receiving, routing, and storing of application programs, electronic messages, and other information associated with features of the booth network. The server 404 can include a server engine, a content management component, and a database management component. The server engine performs basic processing and operating system level tasks. The content management component handles many of the functions (e.g., managing the functionality of the booths 400, updating the backdrops and/or other software features of the booths, etc.) in the embodiments described herein. In other embodiments, these functions can be performed by the booths 400 themselves.

The database management component of the server 404 includes storage and retrieval tasks with respect to a database 408 coupled to the server 404, queries to the database 408, and storage of data. The database 408 can store at least some of the content exchanged between the booths 400, user profile information (e.g., previous photos, user preferences, past purchases, etc.), and/or information related to the studio sessions. As will be apparent to those skilled in the art, the server 404 can include a single server or a plurality of servers, and the database 408 can include a single database or a plurality of databases. Additionally, the server 404, including the database 408, may employ security measures to inhibit malicious attacks on the system and to preserve the integrity of the messages and data stored therein (e.g., firewall systems, secure socket layers (SSL) password protection schemes, encryption, and the like).

In the illustrated embodiment, the communications link 402 is also connected to one or more financial institutions 406 (e.g., banks). The booths 400 can communicate with the financial institutions 406 via the communications link 402 to perform credit and/or debit card transactions, provide payment options, and/or identify users. The communications link 402 can also connect the booths 400 to remote personal devices, such as personal computers 408 and/or smart phones 410 where users can browse previously taken photos, edit the photos, order prints of the photos, and edit user profiles.

A network environment, such as the network environment illustrated in FIG. 4, can connect multiple booths 400 positioned in a plurality of publicly accessible areas, such as malls, department stores, and drug stores. The maintenance and inventory of the networked booths 400 can then be managed from the backend by the server 404 and the database 408. The server 404, for example, can run routine maintenance checks on the booths 400 to identify mechanical problems and/or glitches in the user interface and display pages. The server 404 and the database 408 can also monitor the booth inventory to determine when each booth 400 needs to be restocked with printing paper, ink, and/or other items used by the booths 400 (e.g., rather than having a maintenance person perform regular checkups). Additionally, the network environment allows additional backdrops (e.g., various different location themes) to be added to the database 408 and uploaded to one or more of the booths 400 from the backend. Other information, such as operating systems updates, can also be uploaded to the booths 400 from the backend via the communications link 402. The network environment further allows the user profile information to be stored in the database 408 and shared among the booths 400 in the network.

From the foregoing, it will be appreciated that specific embodiments of the disclosure have been described herein for purposes of illustration, but that various modifications may be made without deviating from the spirit and scope of the invention. For example, although the embodiments shown in FIG. 2A-3J interact with users via touch screens 124 and 128, in other embodiments the booth 100 can interact with users via additional and/or different types of user interfaces. In some embodiments, for example, the booth 100 includes monitor, a keyboard and/or a mouse to receive information from and provide information to users. Aspects of the invention described in the context of particular embodiments may be combined or eliminated in other embodiments. Further, while advantages associated with certain embodiments of the invention have been described in the context of those embodiments, other embodiments may also exhibit such advantages, and no embodiment need necessarily exhibit such advantages to fall within the scope of the invention. Accordingly, the invention is not limited, except as by the appended claims.

I/we claim:

1. A method of taking a photo in an interactive photo booth, the method comprising:
providing a backdrop within the interactive photo booth, wherein the backdrop is configured to provide a plurality of virtual backgrounds;
capturing at least one photo of a user in front of the backdrop in the interactive photo booth; and
receiving, via a user interface at the interactive photo booth, a plurality of user inputs to edit the photo of the user.

2. The method of claim 1, further comprising sending a digital verion of the edited photo to the user via text message and/or email.

3. The method of claim 1, further comprising uploading the edited photo to a remote database.

4. The method of claim 1, further comprising:
receiving, via the user interface, login information for a user account on a social networking site; and
uploading the edited photo to the social networking site.

5. The method of claim 1, further comprising sending a hyperlink to the user via text message and/or email, wherein the hyperlink connects to a site including the edited photo.

6. The method of claim 1, further comprising receiving a user selection for a background scene, wherein the selected background scene is provided on the backdrop via chroma key compositing.

7. The method of claim 6 wherein receiving the user selection for the background scene comprises receiving a user selection for a multiplane background scene.

8. The method of claim 1, further comprising displaying, via a screen, live video of the user in front of the background scene before capturing the photograph.

9. The method of claim 1, further comprising displaying, via a screen, a snapshot of the captured photo after the photo is taken and before a subsequent photo is captured.

10. The method of claim 1 wherein receiving the plurality of user inputs to edit the photo comprises receiving, via the user interface at least two inputs to simultaneously edit different photos.

11. The method of claim 1, further comprising printing the edited photo at the interactive photo booth.

12. The method of claim 1, further comprising:
receiving a code; and
providing a plurality of virtual backgrounds associated with the code.

13. A method of taking and editing photos, the method comprising:
providing a consumer operated kiosk having a housing that defines an enclosure, a camera directed toward a backdrop within the enclosure, and at least one user interface;
receiving a user selection of a virtual background to be provided on the backdrop;
taking at least one photo of a user within the enclosure in front of the selected virtual backgrounds; and
receiving user selections to edit the photo via the user interface.

14. An interactive photo booth, comprising:
a housing that defines an enclosure, the enclosure being sized to receive at least one user;
a backdrop within the enclosure and configured to provide a plurality of virtual backgrounds;
a camera directed toward the backdrop, wherein the camera is configured to take one or more photos of the one user;
a user interface on the housing and configured to receive user selections related to the backdrop and/or editing the photos after the photos are taken.

15. The interactive photo booth of claim 14 wherein the user interface is one of a plurality of user interfaces, the plurality of user interfaces comprising:
a first user interface within the enclosure, wherein the first user interface is configured to receive user selections related to the backdrop and display live images of users in front of selected backgrounds; and
a second user interface on an exterior of the housing, wherein the second user interface is configured to receive user selections to edit the one or more photos.

16. The interactive photo booth of claim 14 wherein the second user interface is a multi-touch screen configured to simultaneously edit more than one photo based on multiple user selections.

17. The interactive photo booth of claim 14 wherein the interactive photo booth is communicatively coupled to a communications link and configured to send digital versions of edited photos to users via email and/or text message.

18. The interactive photo booth of claim 14, further comprising means for editing the photos.

19. The interactive photo booth of claim 14, further comprising a printer configured to print edited photos.

20. The interactive photo booth of claim 14 wherein the backdrop is configured to provide virtual multiplane backgrounds via chroma key compositing.
